(19) United States
(12) Patent Application Publication
(10) Pub. No.: US 2009/0057938 A1
(43) Pub. Date: Mar. 5, 2009

(54) Closed Loop Control for an Injection Unit

(75) Inventor: Gong ZHANG, North York (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/846,051

(22) Filed: Aug. 28, 2007

(51) Int. Cl. B29C 45/76

(52) U.S. Cl. 264/40.1; 425/143

(57) ABSTRACT

A method is provided for improving melt quality in an injection unit. A closed loop control system regulates operation of the injection unit in accordance with a reference value for at least one operating parameter. A sensor measures the present value of a load upon the motor which drives an injection screw during operation of the injection unit. A processor compares the present value of the load to a reference value for the load. If the present value of the load deviates from the reference value of the load by more than a predetermined amount, then the processor adjusting the reference value of the at least one operating parameter. Operating parameters can include barrel temperature, back pressure and screw RPMs.

### FIELD OF INVENTION

The present invention generally relates to injection units. More specifically, the present invention relates to methods for regulating operating parameters to ensure melt quality.

### BACKGROUND OF INVENTION

The injection molding process typically comprises preparing a polymeric (or sometimes metal) material in an injection unit of a molding system, injecting the now-melted material under pressure into a closed and clamped mold, solidifying the material in its molded shape, opening the mold and ejecting the part before beginning the next cycle. The molding material typically is supplied to the injection unit from a hopper in the form of pellets or powder. The injection unit transforms the solid material into a molten material (sometimes called a “melt”), typically using a feed screw, which is then injected into a hot runner or other molding system under pressure from the feed screw or a plunger unit. A shut off valve assembly is typically provided to stop and start the flow of molten material from the barrel to the molding system.

In the plastic injection process, screw torque (i.e., the load on the screw), melt quality, recovery rate and throughput are target variables to be controlled. The temperature of the molten material plays an important role in controlling these variables. The energy to melt the material is provided by the barrel's heater bands that are distributed across the length of the barrel, and by screw rotational shear energy. It is relative easy to control the melt temperature by adjusting the heating of different zone heaters. Generally speaking, in prior art injection units, the operator attempts to maintain and stabilize the temperature of different zones of the barrel, and further attempts to stabilize screw rotation speed (in RPM) at its set value.

Efforts have been made to improve melt quality and other target variables. For example, U.S. Pat. No. 4,256,678 to Shigeru et al. teaches a method of and apparatus for controlling a plasticizing process of a resin of an in-line screw-type injection molding machine, a position of the screw is continuously detected in accordance with the movement thereof and a control function is determined by a back pressure of the screw which is compensated for by taking into consideration such as resin heating energy and shearing energy, which determine a temperature distribution of a resin to be injected. The operating condition, particularly the number of revolutions and the back pressure of the screw, is controlled on the basis of the screw position so as to make uniform the temperature distribution of the resin.

U.S. Pat. No. 4,851,170 to Shimizu et al. teaches an injection molding apparatus using a motor as a driving source, the injection speed and the injection pressure are controlled via a speed sensor, a pressure sensor and a closed loop control system, to provide higher accuracy and better operability during switching of the apparatus from an injection speed control phase to an injection pressure control phase and thereafter to a back pressure control phase.

U.S. Pat. No. 5,360,329 to Lemelson teaches an apparatus for molding permits a fluent molding material to be flowed into a mold cavity for shaping into a configuration defined by the mold walls. A master controller controls the transfer of heat with respect to the molding material, to control the temperature of the molding material in a predetermined way. A sensor measures the temperature of the molding material flowed into the cavity and produces feedback signals, which are compared to reference signals indicative of a desired molding material temperature. The apparatus generates a further control signal, which is applied to control the variables of the molding operation, including the temperature of the molding material and the flow rate.

U.S. Pat. No. 5,885,624 to Katsuta et al teaches an apparatus for a feed-back control of an injection molding machine, comprising a control target which operational conditions are different in accordance with operational purposes; and a control unit for subjecting said control target to a feed-back control, is characterized in that said control unit comprises a judgment function section for judging operational purposes of the control target, a condition setting section for setting operational conditions in accordance with the operational purposes and a switching section for switching the condition setting section through the judgment function section.

U.S. Pat. No. 5,997,778 to Bulgrin teaches an injection molding machine uses a summed, multi-term control law to control ram velocity during the injection stroke of a molding cycle to emulate a user set velocity profile. An automatic calibration method sets no load ram speeds to duplicate user set ram speeds. Finite impulse response filters produce open loop, no load control signals at advanced positions on the velocity profile to account for lag in system response. An adaptive, error term indicative of load disturbance, observed from a preceding cycle is added at the advanced travel position predicted by the finite impulse response filter to produce a predictive open loop, load compensated control signal. Finally, an auto tuned PID controller develops a real time, feedback load disturbance signal summed with the open loop control signal to produce a drive signal for the machine's proportioning valve.

U.S. Pat. No. 6,849,212 teaches an injection machine comprising: a heating barrel which heats a powder material, a binder, and a resin material into a molten resin; a screw mounted in the heating barrel to mix the resin material; and a motor which drives the screw in rotation. The injection machine according to the present invention further comprises a through-hole disposed on a side surface of the heating barrel; a pipe in which a solvent for adjusting a viscosity of the resin material is conducted, the pipe being connected to the through-hole; a filter disposed in the through-hole to prevent the resin material from leaking to the pipe; a valve disposed midway on a pipeline of the pipe; a reservoir disposed on an end of the pipeline of the pipe; a load-detecting part which detects a load value of the motor; a controlling part which sets a reference value with respect to a load of the motor; and a driving part which compares the detected load value with the reference value to drive the valve to carry out either one of supply or discharge of the solvent.

### SUMMARY OF INVENTION

According to a first broad aspect of the present invention, there is provided a method for improving melt quality in an injection unit, comprising:

regulating operation of the injection unit in accordance with a reference value for at least one operating parameter;

measuring a present value of a load upon a motor operable to rotate an injection screw during operation of the injection unit;

comparing the present value of the load to a reference value for the load; and

if the present value of the load deviates from the reference value of the load by more than a predetermined amount, then adjusting the reference value of the at least one operating parameter.

According to a second broad aspect of the invention, there is provided an injection unit, operable to:

regulate its operation in accordance with a reference value for at least one operating parameter;

measure a present value of a load upon a motor operable to rotate an injection screw during the operation of the injection unit;

compare the present value of the load to a reference value for the load; and

if the present value of the load deviates from the reference value of the load by more than a predetermined amount, then adjust the reference value of the at least one operating parameter.

### DETAILED DESCRIPTION OF DRAWINGS

A better understanding of the non-limiting embodiments of the present invention (including alternatives and/or variations thereof) may be obtained with reference to the detailed description of the non-limiting embodiments of the present invention along with the following drawings, in which

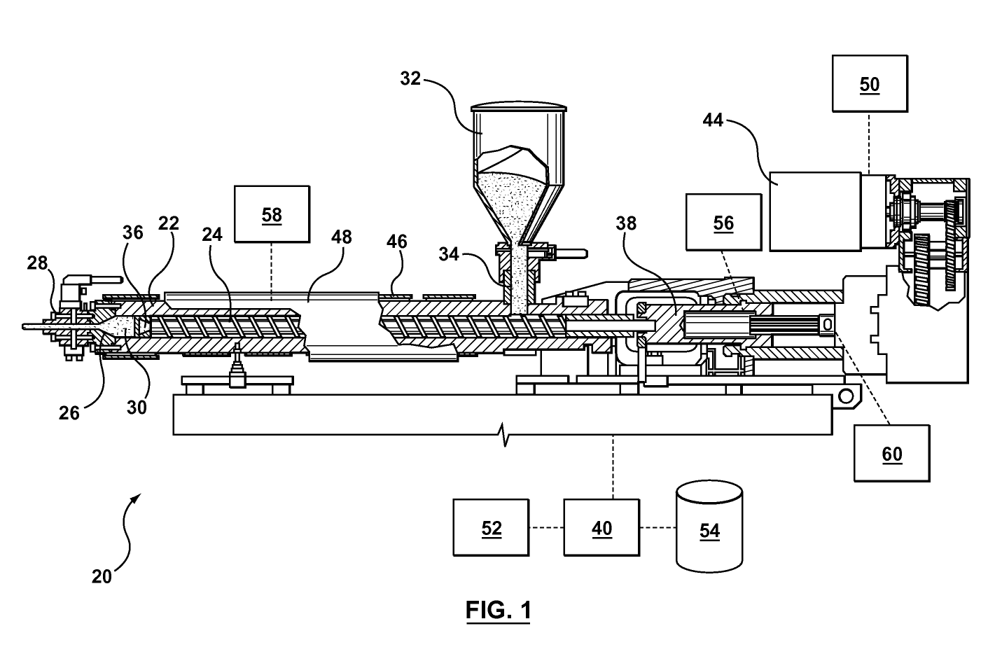

FIG. 1 shows a cross-sectional view of an injection unit, in accordance with an aspect of the invention;

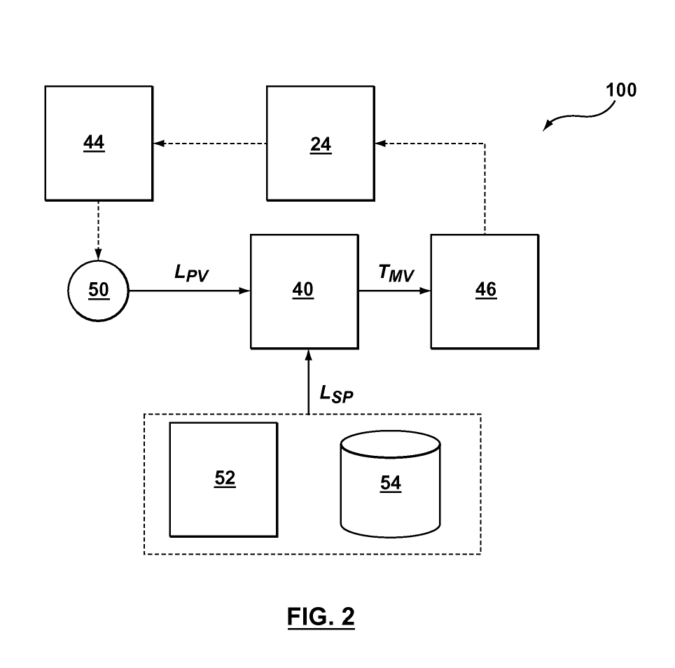

FIG. 2 shows a schematic of a control loop for the injection unit of claim 1;

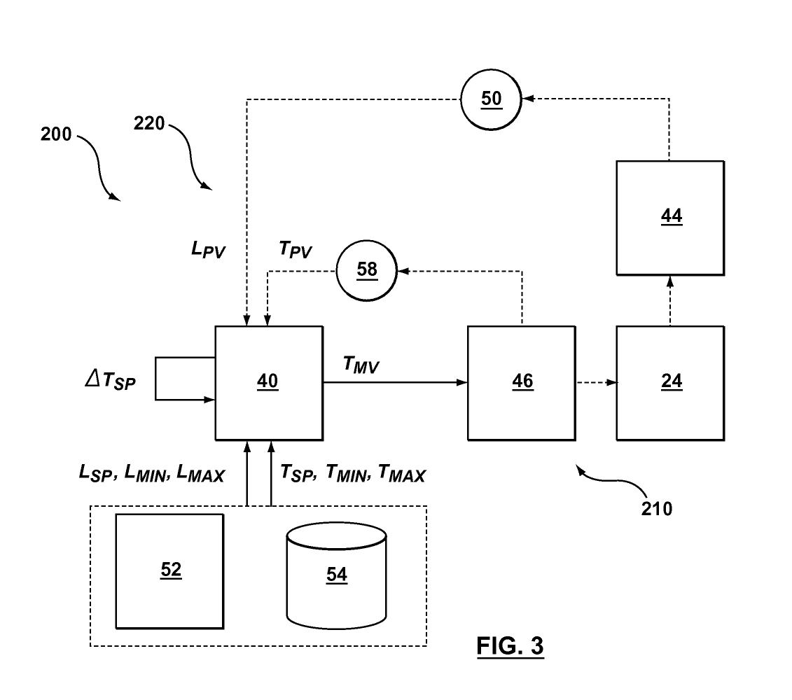

FIG. 3 shows a schematic of a second control loop for the injection unit of claim 1;

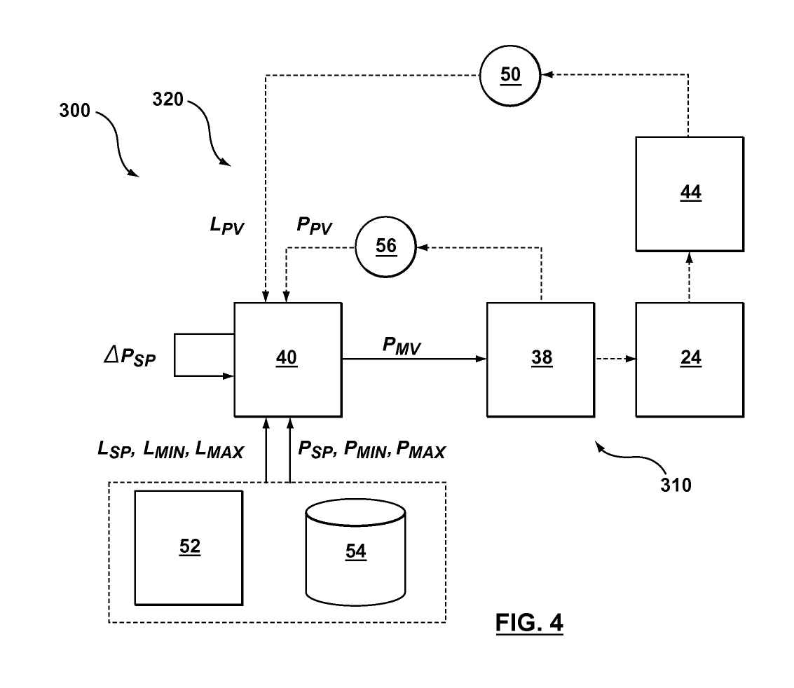

FIG. 4 shows a schematic of a third control loop for the injection unit of claim 1;

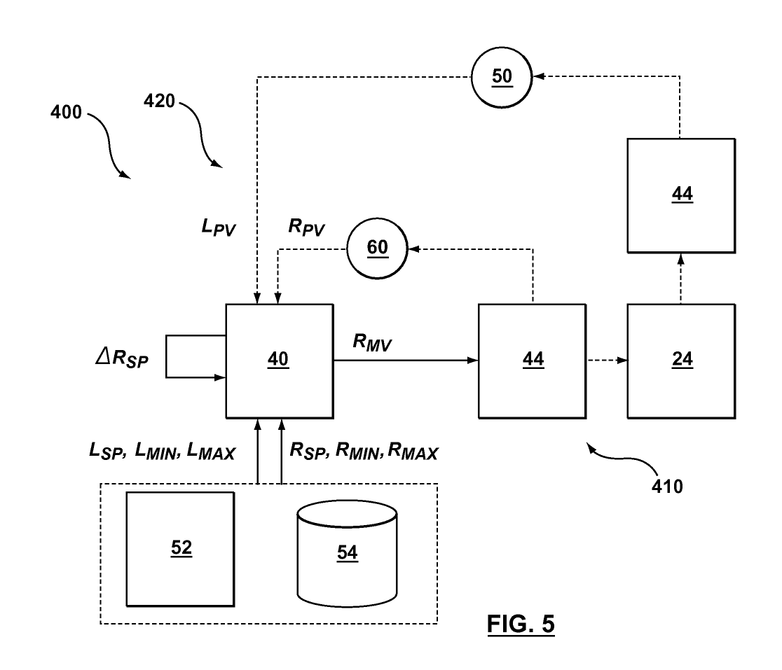

FIG. 5 shows a schematic of a fourth control loop for the injection unit of claim 1; and

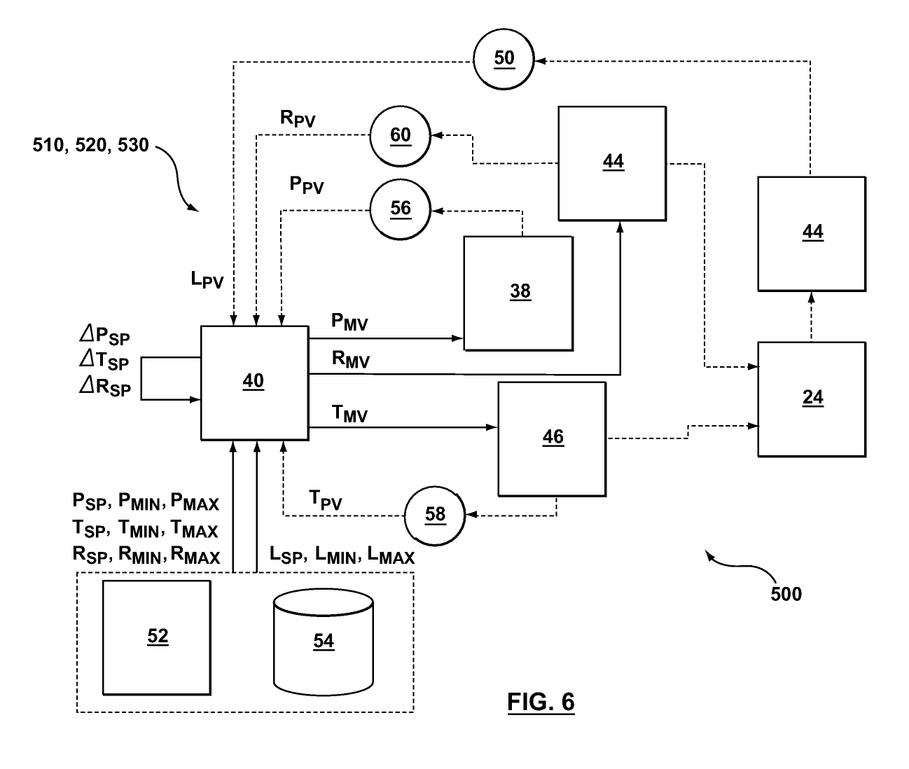

FIG. 6 shows a schematic of a fifth control loop for the injection unit of claim 1.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE NON-LIMITING EMBODIMENTS

Referring now to FIG. 1, an injection unit for a molding system is shown generally at 20, in accordance with a first non-limiting embodiment. The injection unit 20 includes an extrusion barrel 22 adapted to receive an injection screw 24. A cylinder head 26 closes off the end of extrusion barrel 22, and mounts a coaxially aligned nozzle 28. A melt channel 30 is defined between them, extending through barrel 22, cylinder head 26 and nozzle 28.

Material (typically plastic or magnesium alloy pellets) is fed from a hopper 32, through a feed throat 34 into melt channel 30. The rotational movement of screw 24 plasticizes the material prior to it exiting through nozzle 28. Preferably, screw 24 may include a plurality of specialized zones. For example, a first zone might be adapted for conveying solid material from the hopper, a latter zone for compressing and plasticizing the material, and a final for mixing the now-molten material prior to exiting through nozzle 28. Screw 24 may also include weirs or channels to separate out unmelted material from the melted material for further processing. The implementation of screw 24 is not particularly limited and other adaptations will occur to those of skill in the art.

In addition to rotating, screw 24 is preferably operable to reciprocate back and forth to express the melted material out through nozzle 28 and pack the material within a mold (not shown). Preferably, an injection valve 36 is provided near the tip of screw 24 to prevent the reentry of material during the return motion of the screw.

The rotational movements of screw 24 is provided by a motor 44, which may be an electric motor, a hydraulic motor, or a combination thereof (the embodiment depicted in FIG. 1 shows an electric version of motor 44). The rotational movement of screw 24 helps to melt and mix the molten material. Screw 24 is also translatable within barrel 22 via piston 38, in order to apply injection and hold pressure during the molding process. (The embodiment depicted in FIG. 1 shows a hydraulic version of piston 38).

A load sensor 50 is provided for motor 44 that measures the effort required to turn screw 24. Load sensor 50 provides an estimate of the average viscosity of the material within the barrel. Preferably, load sensor 50 is a torque sensor that measures the torque force generated by the motor in order to turn the screw, but other types of sensors could be used. For example, the load sensor could measure the current drawn by the (electric) motor, or it could simply measure the rotational speed (in RPM) of screw 24. Other types of load sensor 50 will occur to those of skill in the art.

Heater bands 46 are provided along a portion of the length of barrel 22 (though away from the feed throat 34) to assist in the melting of the material (in addition to the heat generated by the shearing action of screw 24) and then maintain the temperature of the molten material as it approaches the nozzle. Preferably, heater bands 46 are covered with insulation 48 to minimize heat loss). As is known to those of skill in the art, heater bands 46 typically cycle on and off for fractions of a second so that a 20% duty cycle might represent a low, standby power setting and a 100% duty cycle would be the maximum power cycle. Preferably, each heater band 46 is independently controlled. Thermocouples 58 are provided along the barrel to provide an indication of the material's temperature. Since the thermocouples 58 do not actually contact the material in melt channel 30, they provide only an estimate of its actual temperature.

A processor 40 receives data from various sensors (such as load sensor 50 and thermocouples 58) located within injection unit 20, and further controls the overall operation of injection unit 20, including the rotational and reciprocating movement of screw 24 (via motor 44 and piston 38), heater bands 46 and all related and auxiliary equipment. Processor 40 is preferably a general-purpose computer; however it could also include a plurality of microcontrollers and/or specialized processing units distributed around the various components of injection unit 20.

Processor 40 can be controlled through a Human-Machine Interface (HMI) 52, as the Polaris® control system provided by the Applicant. HMI 52 includes visual display units (either onsite or remotely by network) for an operator as well as input devices for the operator. Processor 40 is also connected to a database 54 either directly or remotely via a network. Database 54 logs the alarms and events, and historical operational data of injection unit 20. Database 54 further maintains saved process parameter and HMI configuration settings for injection unit 20. As is described in greater detail below, database 54 can also store material-specific configuration data such as the minimum value, maximum value and set point value for each operating parameter. While database 54 is depicted as a single data storage device, it is contemplated that database 54 could comprise multiple storage devices locally provided, and/or remotely connected via network.

Processor 40 regulates the operating condition of injection unit 20 using closed or open loop control systems. Processor 40 can include a hardware or software PID controller, or another type of closed or open loop controller. For example, processor 40 controls the duty cycles of each of the heater bands 46. For each thermocouple 58, processor 40 receives a minimum and a maximum temperature (T_{MIN} and T_{MAX} respectively). T_{MIN} represents the minimum operating temperature of melt channel 30 in which the desired level of plasticizing occurs in the material. Below this level, melt quality or operation speed will be compromised to an unsatisfactory degree. T_{MAX} represents the maximum operating temperature of melt channel 30 that can be achieved without risk of damaging the melt quality or parts of the injection unit 20. The values of T_{MIN} and T_{MAX} are dependent upon many factors, including the type and grade of material being plasticized, the final article being produced, the length and rotational speed of screw 24, and other environmental effects. T_{MIN} and T_{MAX} can be inputted by an operator through HMI 52, or through a lookup table in database 54, based upon the material being plasticized and the application.

During operation, if the type of material or grade of material (e.g. MFI, etc.) changes, the viscosity of the molten material will change and generate different load on screw 24. In prior art injection units, a closed loop control system would adjust the power output of the motor in order to change its torque and compensate for the increased screw load, and thereby maintain the RPM target parameter. The inventors have determined that if the processing condition is too challenging for the machine (i.e., the barrel temperature is too low), the closed loop control system cannot keep the rotational speed of screw 24 stable, and furthermore, causes the recovery rate and material throughput to shift or oscillate around the target parameter. To improve operation of the injection unit 20, the inventors monitor the load on screw 24 as a target parameter, and regulate at least one operating parameter, such as barrel temperature, injection back pressure or screw RPM to achieve the targeted load value.

Referring now to FIG. 2, a method for controlling melt quality using a closed loop control system for injection unit 20 is now described generally at 100. Control system 100 regulates the load on screw 24 by manipulating the operating temperatures for injection unit 20. In operation, processor 40 receives as an input signal from load sensor 50 indicating the present value of the load (L_{PV}) required by motor 44 to turn screw 24 (i.e., an estimate of the average viscosity of the material within melt channel 30). Processor 40 compares L_{PV} to a predetermined set point (L_{SP}) for the load on screw 24. The L_{SP} can be provided by an operator inputting a parameter value into HMI 52, or be stored in database 54. If processor 40 determines that the L_{PV} deviates from L_{SP} by more than a predetermined amount, it will then output a control signal (T_{MV}) to increase or decrease the temperature of one or more of the heater bands 46, typically by increasing or decreasing the duty cycle on heater bands. By adjusting the output of one or more of the heater bands 46, the viscosity of the material in melt channel 30 changes, affecting the amount of effort required by motor 44 to rotate screw 24. Once the temperature in melt channel 30 changes, load sensor 50 will receive a new value for L_{PV} In this way, control system 100 can maintain a stable load on screw 24, helping to ensure proper melt quality, recovery time and throughput.

Referring now to FIG. 3, an alternate method for controlling melt quality using a control system is now described at 200. Control system 200 regulates both operating temperature and load. An inner temperature control loop 210 is provided for each heater band 46. Processor 40 receives a minimum temperature value (T_{MIN}), a maximum temperature value (T_{MAX}) and a predetermined temperature set point (T_{SP}) for each heater band 46. The values of T_{MIN}, T_{MAX} and T_{SP} can be provided by an operator via HMI 52, from factory-set values stored in database 54, or from historically determined values stored in database 54. The values of T_{MIN}, T_{MAX} and T_{SP} will be determined by the material being processed, the length of screw 24, environmental and other factors.

Each thermocouple 58 transmits the currently-measured temperature (T_{PV}) to processor 40. When the received T_{PV} deviates from T_{SP} by more than a predetermined amount, processor 40 will output a control signal (T_{MV}) to adjusts the duty cycle of the relevant heater bands 46 so that the measured T_{PV} approaches T_{SP}. (Thermocouples 58 can expect values below T_{SP} during warm-up or standby). Thus, a stable temperature can be achieved in melt channel 30.

An outer control loop 220 is further provided to regulate load on screw 24. Processor 40 receives a minimum load value (L_{MIN}), a maximum load value (L_{MAX}) and an predetermined load set point (L_{SP}) for motor 44. As described earlier, the current load (L_{PV}) is measured by load sensor 50, and typically measures the torque of screw 24. A high torque reading (relative to L_{SP}) typically indicates that the viscosity of the material in the melt channel is too high, and a low torque reading typically indicates that the viscosity of the material is too low.

When the received L_{PV} deviates from L_{SP} by more than a predetermined amount, processor 40 will adjust its temperature set point (ΔT_{SP-MV}). By changing T_{SP}, the inner temperature control loop 210 will then output a control signal (T_{MV}) to adjust the duty cycle of the relevant heater bands 46, as is described above, so that the measured T_{PV} approaches the new ΔT_{SP}.

Preferably, specific values of L_{SP}, L_{MIN}, L_{MAX} and T_{SP}, T_{MIN}, T_{MAX} are available for each different type, brand and grade of material run through injection unit 20. Ideally, these values are stored in database 54 and are provided by the material supplier, the manufacturer or a materials consulting firm. In this way, the machine operator is not required to have detailed knowledge of the material being processed by injection unit 20. Also preferably, these values can be updated over time as the performance of different components changes over time (given screw wear, damage to insulation on the heater bands, etc), and the updated values stored in database 54.

Referring now to FIG. 4, an alternate method for controlling melt quality using a control system is now described at 300. Control system 300 regulates screw load by varying back pressure on screw 24 (i.e., injection speed) via piston 38. An inner pressure control loop 310 is provided for piston 38. Processor 40 receives a minimum pressure value (P_{MIN}), a maximum pressure value (P_{MAX}) and an ideal pressure set point (P_{SP}) for piston 38. The values of P_{MIN}, P_{MAX} and P_{SP} can be provided by an operator via HMI 52, from factory-set values stored in database 54, or from historically determined values stored in database 54. The values of P_{MIN}, P_{MAX} and P_{SP} will be determined by the material being processed, the length of screw 24, environmental factors and other factors.

Pressure transducer 56 transmits the currently-measured back pressure (P_{PV}) to processor 40. When the received P_{PV} deviates from P_{SP} by more than a predetermined amount, processor 40 will output a control signal (P_{MV}) to adjust the pressure applied by piston 38 so that the measured P_{PV} approaches P_{SP}.

An outer load control loop 320 is further provided to regulate load on screw 24. Processor 40 receives a minimum load value (L_{MIN}), a maximum load value (L_{MAX}) and an ideal load set point (L_{SP}) for motor 44. As described earlier, the current load (L_{PV}) is measured by load sensor 50, and typically measures the torque of screw 24. A high torque reading (relative to L_{SP}) typically indicates that the viscosity of the material in the melt channel is too high, and a low torque reading typically indicates that the viscosity of the material is too low.

When the received L_{PV} deviates from L_{SP} by more than a predetermined amount, processor 40 will adjust its pressure set point (ΔP_{SP}). By changing P_{SP}, the inner pressure control loop 210 will then output a control signal (P_{MV}) to adjust the back pressure set value P_{SP}, as is described above, so that the measured P_{PV} approaches the new P_{SP}.

As with temperature parameters, specific values of L_{SP}, L_{MIN}, L_{MAX} and P_{SP}, P_{MIN}, P_{MAX} are, preferably, available for each different type, brand and grade of material run through injection unit 20. Ideally, these values are stored in database 54 and are provided by the material supplier, the manufacturer or a materials consulting firm. In this way, the machine operator is not required to have detailed knowledge of the material being processed by injection unit 20. Also preferably, these values can be updated over time as the performance of different components changes over time (given screw wear, damage to insulation on the heater bands, etc), and the updated values stored in database 54.

Referring now to FIG. 5, an alternate method for controlling melt quality using a control system is now described at 400. Control system 400 regulates screw load by varying the rotational speed (i.e., RPMs) of screw 24. An inner RPM control loop 410 is provided for motor 44. Processor 40 receives a minimum RPM value (R_{MIN}), a maximum RPM value (R_{MAX}) and an ideal RPM set point (R_{SP}) for motor 44. The values of R_{MIN}, R_{MAX} and R_{SP} can be provided by an operator via HMI 52, from factory-set values stored in database 54, or from historically determined values stored in database 54. The values of R_{MIN}, R_{MAX} and R_{SP} will be determined by the material being processed, the length of screw 24, environmental factors and other factors.

RPM sensor 60 transmits the currently-measured RPM (R_{PV}) to processor 40. When the received R_{PV} deviates from R_{SP} by more than a predetermined amount, processor 40 will output a control signal (R_{MV}) to adjust the RPM outputted by motor 44 so that the measured R_{PV} approaches R_{SP}.

An outer load control loop 420 is further provided to regulate the load on screw 24. Processor 40 receives a minimum load value (L_{MIN}), a maximum load value (L_{MAX}) and an predetermined load set point (L_{SP}) for motor 44. As described earlier, the current load (L_{PV}) is measured by load sensor 50, and typically measures the torque of screw 24. A high torque reading (relative to L_{SP}) typically indicates that the viscosity of the material in the melt channel is too high, and a low torque reading typically indicates that the viscosity of the material is too low.

When the received L_{PV} deviates from L_{SP} by more than a predetermined amount, processor 40 will adjust its RPM set point (ΔR_{SP}). By changing R_{SP}, the inner RPM control loop 410 will then output a control signal (R_{MV}) to adjust the RPM set value R_{SP}, as is described above, so that the measured R_{PV} approaches the new R_{SP}.

As with temperature parameters, specific values of L_{SP}, L_{MIN}, L_{MAX} and R_{SP}, R_{MIN}, R_{MAX} are, preferably, available for each different type, brand and grade of material run through injection unit 20. Ideally, these values are stored in database 54 and are provided by the material supplier, the manufacturer or a materials consulting firm. In this way, the machine operator is not required to have detailed knowledge of the material being processed by injection unit 20. Also preferably, these values can be updated over time as the performance of different components changes over time (given screw wear, damage to insulation on the heater bands, etc), and the updated values stored in database 54.

Referring now to FIG. 6, an alternate method for controlling melt quality using a control system is now described at 500. Control system 500 regulates screw load by varying temperature, back pressure on screw 24 and RPM speeds of screw 24. Control system 500 includes a temperature control loop 510, which regulates the barrel temperature to approach T_{SP}. Control system 500 further includes a back pressure control loop 520 which regulates the screw pressure to approach P_{SP}. Control system 500 also includes a RPM control loop 530, which regulates the screw's rotational speed to approach R_{SP}.

As with the previously-described embodiments, the values of T_{SP}, P_{SP} and R_{SP} are adjusted by an outer loop that regulates the measured load value (L_{MV}). Processor 40 determines which of the inner loops will be fine-tuned to correct the value of L_{MV}. For example, processor 40 may first adjust the temperature set point via control loop 510. If additional adjustments are required, processor 40 may then adjust the back pressure set point via control loop 520. If additional adjustments are still required, processor 40 may then adjust the screw's rotational speed set point via control loop 530.

Alternatively, processor 40 may adjust several of the inner parameters simultaneously. The degree of the adjustment may be equal for some or all of the three parameters, or the degree of change may be weighted differently between control loops.

Non-limiting embodiments of the present invention may provide a control system for an injection unit having a better quality and higher throughput of molten material. Non-limiting embodiments of the present invention may provide a control system for an injection unit that reduces wear on the screw and the motor. Non-limiting embodiments of the present invention may provide a control system for an injection unit having a reduced force requirement for actuation. Non-limiting embodiments of the present invention may provide a control system for an injection unit that provides customized, material specific data for better performance.

The description of the non-limiting embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the non-limiting embodiments, it will be apparent that modifications and enhancements are possible without departing from the concepts as described. Therefore, what is to be protected by way of letters patent are limited only by the scope of the following claims.

What is claimed is:

1. A method for improving melt quality in an injection unit, comprising:
regulating operation of the injection unit in accordance with a reference value for at least one operating parameter;
measuring a present value of a load upon a motor operable to rotate an injection screw during operation of the injection unit;
comparing the present value of the load to a reference value for the load; and
if the present value of the load deviates from the reference value of the load by more than a predetermined amount, then adjusting the reference value of the at least one operating parameter.

2. The method of claim 1, wherein the at least one operating parameter includes barrel temperature.

3. The method of claim 1, wherein the at least one operating parameter includes injection back pressure.

4. The method of claim 1, wherein the at least one operating parameter includes rotational speed of the injection screw.

5. The method of claims 2 to 4, wherein the reference value of the at least one operating parameter is bound between a minimum value and a maximum value.

6. The method of claim 5, wherein the at least one operating parameter comprises at least two operating parameters.

7. The method of claim 6, wherein the reference value of one of the at least two operating parameters is adjusted and the present value of the load is re-measured prior to adjusting the reference value of another of the at least two operating parameters.

8. The method of claim 7, wherein more than one of the at least two operating parameters is adjusted simultaneously.

9. The method of claim 6, wherein at least one of the reference value for the load, the minimum value for the load, the maximum value for the load, the reference value for the at least one operating parameter, the minimum value for the at least one operating parameter, and the maximum value for the at least one operating parameter is set by an operator using a human-machine interface.

11. The method of claim 6, wherein at least one of the reference value for the load, the minimum value for the load, the maximum value for the load, the reference value for the at least one operating parameter, the minimum value for the at least one operating parameter, and the maximum value for the at least one operating parameter is provided by a database.

12. The method of claim 11, wherein the value of any of the at least one of the reference value for the load, the minimum value for the load, the maximum value for the load, the reference value for the at least one operating parameter, the minimum value for the at least one operating parameter, and the maximum value for the at least one operating parameter provided by the database is based upon which material is being processed by the injection unit.

13. The method of claim 2, wherein the load on the motor is measured by determining the torque output of the motor.

14. The method of claim 2, wherein the load on the motor is measured by determined current drawn by the motor.

15. The method of claim 1, wherein regulating operation of the injection unit in accordance with the reference value for the at least one operating parameter includes using closed loop control for the at least one operating parameter.

16. The method of claim 1, wherein regulating operation of the injection unit in accordance with the reference value for the at least one operating parameter includes using open loop control for the at least one operating parameter.

17. An injection unit, operable to:
regulate its operation in accordance with a reference value for at least one operating parameter;
measure a present value of a load upon a motor operable to rotate an injection screw during the operation of the injection unit;
compare the present value of the load to a reference value for the load; and
if the present value of the load deviates from the reference value of the load by more than a predetermined amount, then adjust the reference value of the at least one operating parameter.

18. The injection unit of claim 17, wherein the at least one operating parameter includes barrel temperature.

19. The injection unit of claim 17, wherein the at least one operating parameter includes injection back pressure.

20. The injection unit of claim 17, wherein the at least one operating parameter includes rotational speed of the injection screw.

21. The injection unit of claims 18 to 20, wherein the reference value of the at least one operating parameter is bound between a minimum value and a maximum value.

22. The injection unit of claim 21, wherein the at least one operating parameter comprises at least two operating parameters.

23. The injection unit of claim 22, wherein the reference value of one of the at least two operating parameters is adjusted and the present value of the load is re-measured prior to adjusting the reference value of another of the at least two operating parameters.

24. The injection unit of claim 22, wherein more than one of the at least two operating parameters is adjusted simultaneously.

25. The injection unit of claim 23, wherein at least one of the reference value for the load, the minimum value for the load, the maximum value for the load, the reference value for the at least one operating parameter, the minimum value for the at least one operating parameter, and the maximum value for the at least one operating parameter is set by an operator using a human-machine interface.

26. The injection unit of claim 23, wherein at least one of the reference value for the load, the minimum value for the load, the maximum value for the load, the reference value for the at least one operating parameter, the minimum value for the at least one operating parameter, and the maximum value for the at least one operating parameter is provided by a database.

27. The injection unit of claim 26, wherein the value of any of the at least one of the reference value for the load, the minimum value for the load, the maximum value for the load, the reference value for the at least one operating parameter, the minimum value for the at least one operating parameter, and the maximum value for the at least one operating parameter provided by the database is based upon which material is being processed by the injection unit.

28. The injection unit of claim 18, wherein the load on the motor is measured by determining the torque output of the motor.

29. The injection unit of claim 18, wherein the load on the motor is measured by determining current drawn by the motor.

30. The injection unit of claim 17, wherein regulating operation of the injection unit in accordance with the reference value for the at least one operating parameter includes using closed loop control for the at least one operating parameter.

31. The injection unit of claim 17, wherein regulating operation of the injection unit in accordance with the reference value for the at least one operating parameter includes using open loop control for the at least one operating parameter.
